(19) United States
(12) Patent Application Publication
(10) Pub. No.: US 2023/0224662 A1
(43) Pub. Date: Jul. 13, 2023

(54) APPARATUS AND METHOD FOR GENERATING IMPULSE RESPONSE USING RAY TRACING

(71) Applicant: ELECTRONICS AND TELECOMMUNICATIONS RESEARCH INSTITUTE, Daejeon (KR)

(72) Inventors: Yong Ju LEE, Daejeon (KR); Jae-hyoun YOO, Daejeon (KR); Dae Young JANG, Daejeon (KR); Kyeongok KANG, Daejeon (KR); Tae Jin LEE, Daejeon (KR)

(21) Appl. No.: 18/146,685

(22) Filed: Dec. 27, 2022

(30) Foreign Application Priority Data
Jan. 13, 2022 (KR) 10-2022-0005411

(51) Int. Cl. H04S 7/00

(52) U.S. Cl. CPC H04S 7/302

(57) ABSTRACT

Provided is a method and apparatus for generating an impulse response using ray tracing. The method of generating an impulse response may include calculating a number of rays reaching a receiver from a transmitter based on acoustic geometry information including a position of the transmitter and a position of the receiver disposed in a sound space, a maximum ray length or a sound space volume, and a radius of the receiver, tracing the rays using a path of the calculated rays, and generating an impulse response based on the traced rays.

### CROSS-REFERENCE TO RELATED APPLICATION

This application claims the benefit of Korean Patent Application No. 10-2022-0005411 filed on Jan. 13, 2022, in the Korean Intellectual Property Office, the entire disclosure of which is incorporated herein by reference for all purposes.

### BACKGROUND

### 1. Field of the Invention

One or more example embodiments relate to a method and apparatus for generating an impulse response by tracing rays deriving from an object-based audio.

### 2. Description of the Related Art

Spatial rendering is required to perform the rendering of object-based audio. Spatial information may include various information such as a distance or an angle between a listener and an object-based audio and be used to perform the rendering of the object-based audio. An impulse response may be generated based on acoustic geometry information to perform the rendering of the object-based audio. In this case, the impulse response may be divided into direct sound, early reflected sound, and reverberation. A method of improving the accuracy of such an impulse response is needed.

### SUMMARY

One or more example embodiments provide a method and apparatus for generating an impulse response by tracing rays deriving from an object-based audio.

According to an aspect, there is provided a method of generating an impulse response including calculating a number of rays reaching a receiver from a transmitter based on acoustic geometry information including a position of the transmitter and a position of the receiver disposed in a sound space, a maximum ray length or a sound space volume, and a radius of the receiver, tracing the rays using a path of the calculated rays, and generating an impulse response based on the traced rays.

The calculating of the number of the sound rays may include calculating the number of the rays based on the radius of the receiver and the maximum ray length.

The calculating of the number of the rays may include calculating the number of the rays based on the radius of the receiver and the sound space volume.

The generating of the impulse response may include generating the impulse response based on a direct sound representing a ray corresponding to a path directly reaching the receiver from the transmitter and a reflected sound representing a ray corresponding to a path originating from the transmitter and reaching the receiver after reflection in the sound space.

According to an aspect, there is provided a method of generating an impulse response, including calculating a number of rays reaching a receiver from a transmitter based on acoustic geometry information including a position of the transmitter and a position of the receiver disposed in a sound space, a maximum ray length or a sound space volume, and a radius of the receiver, tracing the rays using a path of the calculated rays, generating an impulse response based on the traced rays, and reflecting a penetration path of a direct sound in the impulse response according to whether the direct sound is included in the impulse response.

The calculating of the number of the rays may include calculating the number of the rays based on the radius of the receiver and the maximum ray length.

The calculating of the number of the rays may include calculating the number of rays based on the radius of the receiver and the sound space volume.

The generating of the impulse response may include generating the impulse response based on the direct sound representing a ray corresponding to a path directly reaching the receiver from the transmitter and a reflected sound representing a ray corresponding to a path originating from the transmitter and reaching the receiver after reflection in the sound space.

The reflecting in the impulse response may include outputting the impulse response generated based on the traced rays, as it is, when the direct sound is included in the impulse response.

The reflecting in the impulse response may include reflecting, in the impulse response, the direct sound corresponding to a path penetrating an obstacle disposed in the sound space, when the direct sound is not included in the impulse response.

The direct sound corresponding to the path penetrating the obstacle is determined differently according to characteristics of penetrating the obstacle.

The reflecting in the impulse response may include determining that the direct sound is included in the impulse response according to whether a length of an impulse path occurring at a closest distance from the impulse response is equal to a distance between the transmitter and the receiver.

According to an aspect, there is provided an impulse-response generating apparatus that includes a processor. The processor may be configured to calculate the number of rays reaching a receiver from a transmitter based on acoustic geometry information including a position of the transmitter and a position of the receiver disposed in a sound space, a maximum ray length or a sound space volume, and a radius of the receiver, trace the rays using a path of the calculated rays, generate an impulse response based on the traced rays, and reflect a penetration path of a direct sound in the impulse response according to whether the direct sound is included in the impulse response.

The processor may be configured to calculate the number of the rays based on the radius of the receiver and the maximum ray length.

The processor may be configured to calculate the number of the rays based on the radius of the receiver and the sound space volume.

The processor may be configured to generate the impulse response based on the direct sound representing a ray corresponding to a path directly reaching the receiver from the transmitter and a reflected sound representing a ray corresponding to a path originating from the transmitter and reaching the receiver after reflection in the sound space.

The processor may be configured to output the impulse response generated based on the traced ray, as it is, when the direct sound is included in the impulse response.

The processor may be configured to reflect, in the impulse response, the direct sound corresponding to a path of penetrating an obstacle disposed in the sound space when the direct sound is not included in the impulse response.

The direct sound in the path penetrating the obstacle may be determined differently according to the characteristics of penetrating the obstacle.

The processor may be configured to determine that the direct sound is included in the impulse response according to whether a length of an impulse path occurring at a closest distance in the impulse response is equal to a distance between the transmitter and the receiver.

Additional aspects of example embodiments will be set forth in part in the description which follows and, in part, will be apparent from the description, or may be learned by practice of the disclosure.

According to example embodiments, an impulse response may be improved by tracing a ray deriving from object-based audio.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an operating method of an impulse-response generating apparatus according to an example embodiment;

FIG. 2 is a diagram illustrating an operating method of an impulse-response generating apparatus according to another example embodiment;

FIGS. 3A and 3B are diagrams illustrating a relationship between the number of rays and a receiver according to an example embodiment;

FIGS. 4A and 4B are diagrams illustrating a relationship between a size of a receiver and a ray according to an example embodiment;

FIGS. 5A and 5B are diagrams illustrating an impulse response and the paths of rays according to a direct reflected sound when an obstacle does not exist according to an example embodiment;

FIGS. 5C and 5D are diagrams illustrating an impulse response and the paths of rays according to a direct reflected sound when an obstacle exists according to an example embodiment;

FIG. 6 is a diagram illustrating a transmittance of an object in consideration of an impulse response according to an example embodiment;

FIG. 7 is a diagram illustrating an impulse response according to a direct reflected sound when an obstacle exists according to an example embodiment;

FIGS. 8A and 8B are diagrams illustrating an impulse response reflecting a penetration path according to an example embodiment; and

FIG. 9 is a diagram illustrating an impulse response reflecting a penetration path according to another example embodiment.

### DETAILED DESCRIPTION

Hereinafter, example embodiments will be described in detail with reference to the accompanying drawings. The scope of the right, however, should not be construed as limited to the example embodiments set forth herein. In the drawings, like reference numerals are used for like elements.

Various modifications may be made to the example embodiments. Here, the example embodiments are not construed as limited to the disclosure and should be understood to include all changes, equivalents, and replacements within the idea and the technical scope of the disclosure.

Although terms of “first” or “second” are used to explain various components, the components are not limited to the terms. These terms should be used only to distinguish one component from another component. For example, a first component may be referred to as a second component, and similarly the second component may also be referred to as the first component.

The terminology used herein is for the purpose of describing particular examples only and is not to be limiting of the examples. As used herein, the singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the examples with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

Hereinafter, example embodiments will be described in detail with reference to the accompanying drawings.

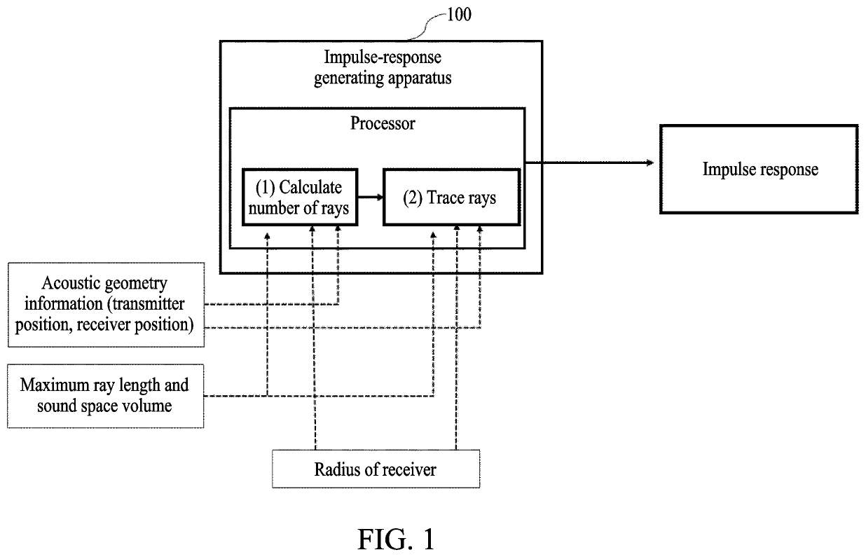

FIG. 1 is a diagram illustrating an operating method of an impulse-response generating apparatus according to an example embodiment.

Referring to FIG. 1, an impulse-response generating apparatus 100 may generate an impulse response using various spatial information. The impulse-response generating apparatus 100 may include a processor and perform a method of generating the impulse response through the processor.

In operation 1, the impulse-response generating apparatus 100 may calculate the number of rays. Here, the rays may refer to a plurality of signals output from an object-based audio, which is a sound source. By tracing the rays, a direct sound and a direct reflected sound may be generated between a sound source and a user (a listener). An impulse response may be determined between the sound source and the user based on the direct sound and the direct reflected sound.

A process of tracing the rays may include disposing a ray transmitter, which is a sound source, and a ray receiver in a specific space, and tracing a path in which rays emitted from the ray transmitter reaches the ray receiver, likewise rays emitted from the ray transmitter to be reflected in a certain space and to reach the ray receiver or rays emitted from the ray transmitter to reach the ray receiver without reflection. The impulse-response generating apparatus 100 may use a path in which rays reach the ray receiver to generate an impulse response between a sound source and a user. Here, the size of the ray receiver may be set to be similar to the size of the head of a listener who is the user. Then, the ray transmitter may correspond to an object-based audio as a sound source, and the ray receiver may correspond to the listener as the user, which may describe a realistic process of generating an impulse response.

The impulse-response generating apparatus 100 may calculate the number of rays based on a radius of the ray receiver, a maximum ray length, a volume of sound space, acoustic geometry information, a ray transmitter position, and a ray receiver position.

In operation 2, the impulse-response generating apparatus 100 may trace rays based on the number of the rays.

According to an example embodiment, the impulse-response generating apparatus 100 may determine the number of rays according to the following Equations 1 and 3. For example, in the present disclosure, the size of the receiver which the rays reach may be set to be the same as or similar to the size of the listener's head. The impulse-response generating apparatus 100 may generate an impulse response by identifying a path (a direct sound) through which a ray directly reaches the receiver from the transmitter and a path (a reflected sound) through which a ray is reflected in a sound space and reaches the receiver.

The impulse-response generating apparaus 100 may use Equation 1 to determine the number of rays according to a maximum ray-tracing path. Equation 1 calculates a minimum radius of the receiver satisfying that at least one ray among two rays passes through the receiver in d_{SR}, which is the maximum ray length. Determining the number of the rays may not directly use information about a sound space, the position of the transmitter and the position of the receiver. However, the acoustic geometry information may be used when the length of the maximum ray-tracing path is determined. The information about the position of the transmitter and the position of the receiver may be used for the actual tracing of the rays.

$${r}_{min} = {d}_{SR} \sqrt{\frac{4}{N}} \qquad [ Equation 1 ]$$

For example, it is assumed that the size of the receiver is fixed at a radius of 0.1 m, similar to the size of a human head, and the length of the maximum ray-tracing path is 100 m. Then, according to Equation 2, the number of the rays may be determined as N=4,000,000.

$$r = {d}_{SR} \times \sqrt{\frac{4}{N}} \qquad [ Equation 2 ]$$

$$N = \frac{{d}_{SR}^{2} \times 4}{{r}^{2}}$$

$$N = \frac{{l}^{2} \times 2 \times π}{{r}^{2}}$$

$$N = 10 {0}^{2} \times 4 \div {0.1}^{2}$$

$$N = 10 {0}^{2} \times 4 \times 100 = 4 , 000 , 000$$

As another example, the impulse-response generating apparatus 100 may determine the number of rays by using Equation 3 representing a relationship between an acoustic geometry volume V, the radius of the receiver r, and the number of rays N.

$$r = 3 \sqrt{\frac{15 V}{2 π N}} \qquad [ Equation 3 ]$$

For example, it is assumed that the size of the receiver is fixed at a radius of 0.1 m, similar to the size of a human head, and the acoustic geometry volume is 500 m³. Then, according to Equation 4, when the acoustic geometry volume is 500 m³, and r=0.1 m is input, the number of rays N is approximately 1,074,840.

$$r = 3 \times \sqrt{\frac{15 \times V}{2 \times π \times N}} \qquad Equation 4$$

$$N = \frac{{3}^{2} \times 15 \times V}{( {r}^{2} \times 2 \times π )}$$

$$N = \frac{{3}^{2} \times 15 \times 500}{( 0 . {1}^{2} \times 2 \times π )}$$

$$N = 1 , 074 , 840.7$$

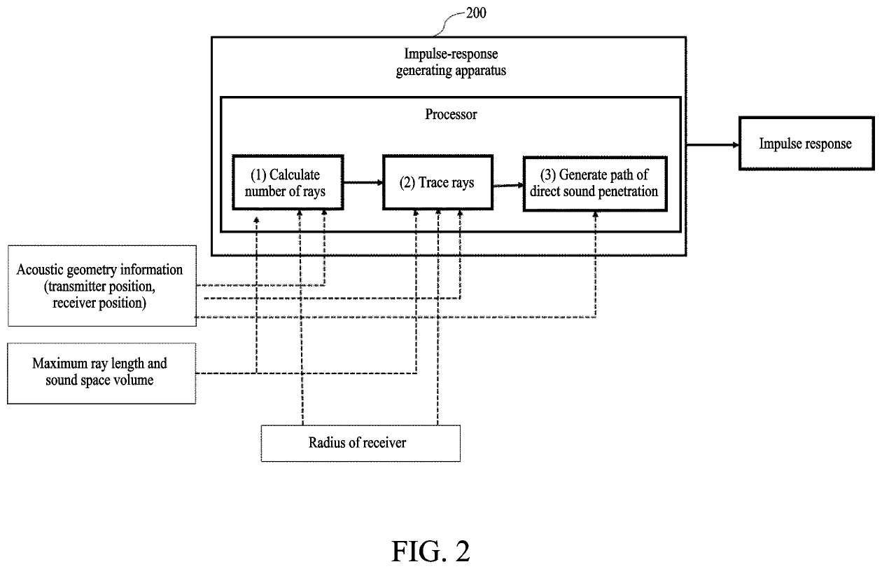

FIG. 2 is a diagram illustrating an operating method of an impulse-response generating apparatus according to another example embodiment.

The impulse-response generating apparatus 200 illustrated in FIG. 2 may additionally generate a penetration path of a direct sound to the impulse-response generating apparatus 100 of FIG. 1 to generate a more improved impulse response.

The description of operation 1 of calculating the number of rays and operation 2 of tracing rays, which are performed by the impulse-response generating apparatus 200, may be the same as the description of FIG. 1. Additionally, the impulse-response generating apparatus 200 may generate the penetration path of the direct sound in operation 3.

The impulse-response generating apparatus 200 may generate the penetration path of the direct sound after the path of the direct sound is determined. The impulse-response generating apparatus 200 may identify whether the direct sound is included in an impulse response while rays are being traced.

When it is determined that the direct sound is included in the impulse response after tracing the ray, the impulse-response generating apparatus 200 may output the impulse response, as it is, derived by tracing the rays. When the direct sound is not included in the impulse response derived after tracing the rays, the impulse response generating apparatus 200 may calculate a path of the direct sound by penetration and add the calculated path to the impulse response derived from a result of the ray tracing.

The impulse-response generating apparatus 200 may determine whether the direct sound is included in the impulse response derived by the ray tracing, through the following process. Whether the direct sound is included in the impulse response may be determined by comparing whether the length of an impulse path generated at the closest distance in the impulse response is equal to the distance between the transmitter and the receiver. When the length of the impulse path generated at the closest distance from the impulse response is the same as the distance between the transmitter and the receiver, it may be determined that the direct sound is included in the impulse response.

When the path of the direct sound is not included in the impulse response, the impulse response generating apparatus 200 may determine that the direct sound is reflected by an obstacle. Then, the impulse response generating apparatus 200 may calculate a penetration path of the direct sound by the obstacle and add the calculated path to the impulse response derived through the ray tracing in operation 2.

When the direct sound is reflected by the obstacle, the penetration path of the direct sound may be generated to supplement a portion which may not reflect the acoustic characteristics of the penetration path of the rays, only with ray tracing. In this way, the impulse response may be generated more realistically.

In the present invention, the size of the receiver is fixed in order to trace rays, and the number of rays may be adjusted in consideration of the maximum ray-tracing path or the size of the space.

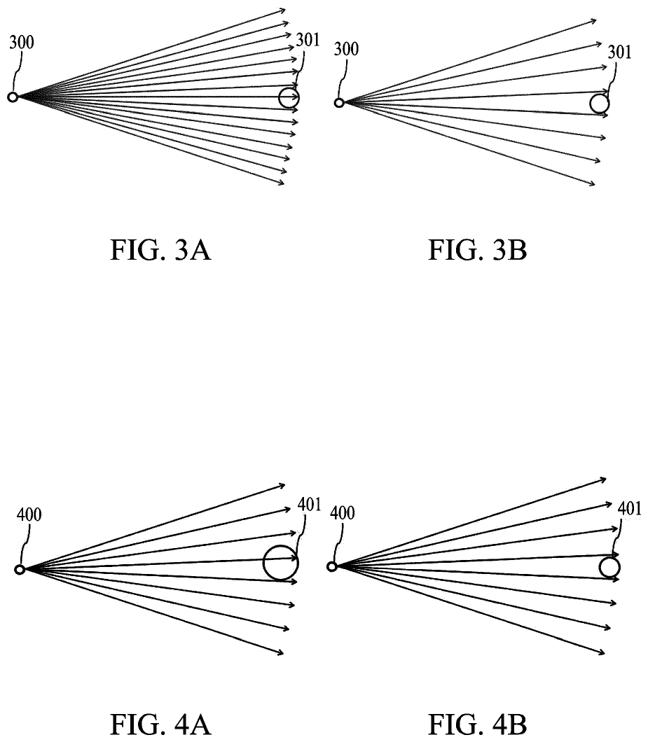

FIGS. 3A and 3B are diagrams illustrating a relationship between the number of rays and a receiver according to an example embodiment.

FIGS. 3A and 3B illustrate the relationship between the number of rays emitted from a transmitter 300 of rays corresponding to object-based audio as a sound source and a receiver 301. Referring to FIGS. 3A and 3B, as the number of rays emitted from the transmitter 300 increases, more rays may penetrate the receiver 301.

That is, since the number of rays in FIG. 3A is greater than the number of rays in FIG. 3B, there may be a ray penetrating the receiver 301 in FIG. 3A having relatively more rays. Therefore, appropriately setting the number of rays may be needed.

FIGS. 4A and 4B are diagrams illustrating a relationship between the size of a receiver and a ray according to an example embodiment.

FIGS. 4A and 4B illustrate a relationship between a ray emitted from a transmitter 400 of rays corresponding to an object-based audio as a sound source and a size of a receiver 301. Referring to FIGS. 4A and 4B, as the size (represented by the radius) of the receiver 400 increases, more rays may penetrate the receiver 401 even when the number of rays emitted from the transmitter 400 is the same.

That is, since the size of the receiver 401 in FIG. 4A is larger than the size of the receiver 401 in FIG. 4B, there may be a ray penetrating the receiver 401 in FIG. 4A having a larger size of the receiver 401 than FIG. 4B, even when the same number of rays are emitted from the transmitter 401. Therefore, appropriately setting the size of the receiver 401 may be needed.

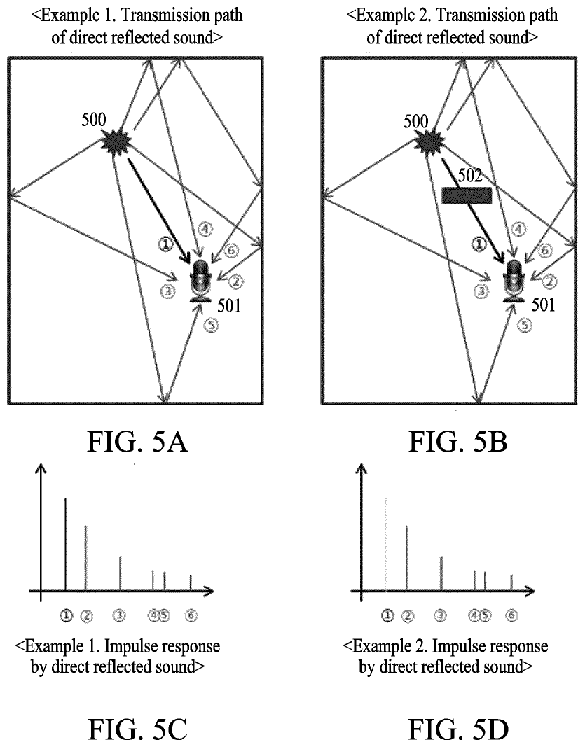

FIG. 5A is a diagram illustrating path of rays when an obstacle does not exist, and FIG. 5B is a diagram illustrating path of rays when an obstacle exists. FIG. 5C is diagram illustrating an impulse response according to a direct reflected sound when an obstacle does not exist according to an example embodiment. FIG. 5D is a diagram illustrating an impulse response according to a direct reflected sound when an obstacle exists according to an example embodiment.

Referring to FIG. 5A, a ray emitted from a transmitter 500 may reach a receiver 501 directly as shown in Path 1 or rays may be reflected in a space to reach the receiver 501 as shown in Paths 2 to 6. In this case, the impulse response may be expressed as a direct sound illustrated in Path 1 and reflected sounds illustrated in Paths 2 to 6.

Referring to FIG. 5B, rays emitted from the transmitter 500 may be reflected in the space and reach the receiver 501, such as Paths 2 to 6. However, in the case of Path 1, a direct sound according to Path 1 is not reflected in the impulse response because the direct sound is reflected by an obstacle 501. To reflect such a direct sound, an impulse-response generating apparatus 200 may also reflect the direct sound, which is penetrated by the obstacle, in the impulse response.

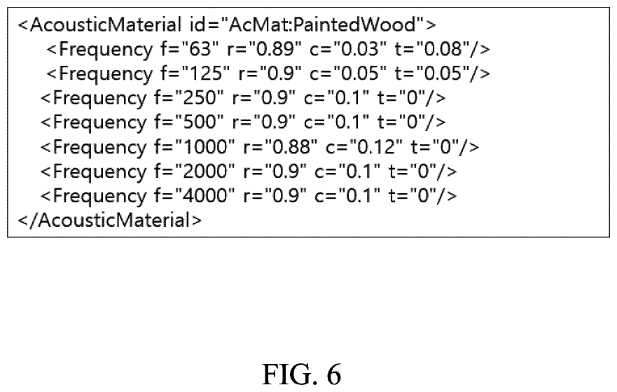

FIG. 6 is a diagram illustrating transmittance of an object in consideration of an impulse response according to an example embodiment.

When a sound encounters an obstacle, the sound may be reflected, but some of the sound may penetrate the obstacle and be transmitted. Thus, the present invention may reflect the sound penetrating the obstacle in the impulse response.

The characteristics of the sound penetrating the obstacle may be determined according to the characteristics of penetrating the obstacle. In general, the transmittance of an object has a value between 0 and 1.0 and may be set differently for each frequency. FIG. 6 shows an example in which specular reflected energy r, coupled energy c, and transmitted energy t of an object are set for each frequency.

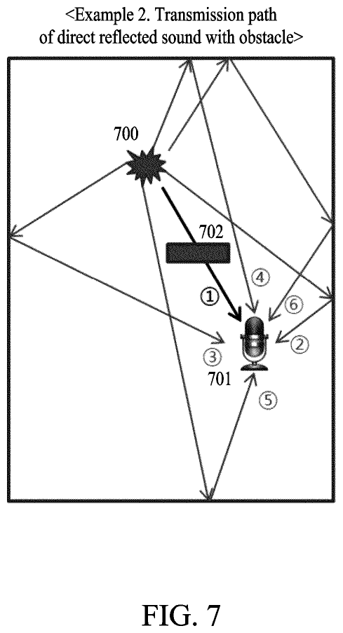

FIG. 7 is a diagram illustrating an impulse response according to a direct reflected ray when an obstacle exists according to an example embodiment.

In FIG. 7, when an obstacle exists as shown in FIG. 5B, Paths 1 to 6 may be determined when rays emitted from a transmitter 700 reach a receiver 701. Here, Paths 1 to 6 may refer to tracing rays.

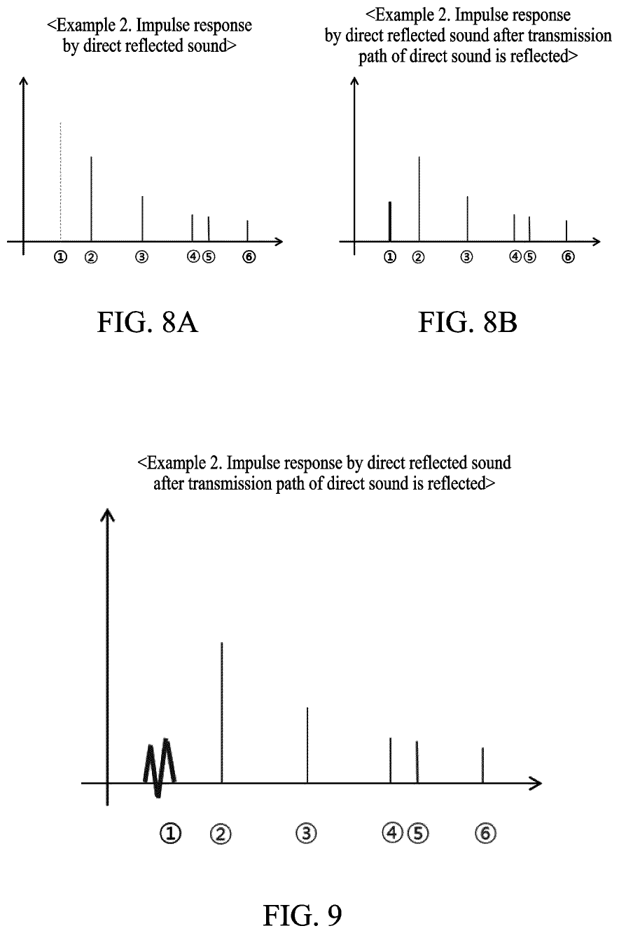

Paths 2 to 6 may be expressed as reflected sounds in an impulse response. However, since a ray may penetrate an obstacle 702 in Path 1, an impulse-response generating apparatus 200 may generate an impulse response which reflects even the ray penetrating the obstacle 702. FIG. 7 illustrates a situation in which a direct sound is not transmitted to a receiver by an obstacle. When a method of tracing rays described herein is used, an impulse response as shown in FIG. 8A may be generated. In this case, the generated impulse response may not include an impulse by a direct sound.

When an obstacle does not exist in a sound space, a response (time of arrival) to the direct sound may be calculated not by the ray tracing but by a distance between the receiver and the transmitter. For example, assuming that the speed of sound is 340 m/sec when the distance between the receiver and the transmitter is 3.40 m, the direct sound may appear in the form of an impulse in about 10 msec.

When the impulse response is calculated by the method of the ray tracing, when there is no impulse response to the direct sound near 10 msec, it may be determined that the direct sound is not transmitted to the receiver by the obstacle. Conversely, when the impulse response is calculated by the method of the ray tracing, when there is the impulse response to the direct sound in the vicinity of 10 msec, it may be determined that the direct sound is transmitted to the receiver without interference with the obstacle.

FIGS. 8A and 8B are diagrams illustrating an impulse response reflecting a penetration path according to an example embodiment.

FIG. 8A shows an impulse response that does not reflect a path penetrating the obstacle 702 of FIG. 7, and FIG. 8B shows an impulse response reflecting the path penetrating the obstacle 702 of FIG. 7.

The impulse response of FIG. 8A may not reflect a reflected sound in Path 1 through which a ray emitted from the transmitter 700 penetrates the obstacle 702, but the impulse response of FIG. 8B may reflect the reflected sound in Path 1.

According to an example embodiment, a ray passing through a path penetrating the obstacle 702 may be reflected in the impulse response.

FIG. 9 is a diagram illustrating an impulse response reflecting a penetration path according to an example embodiment.

FIG. 9 may reflect a path of obstacle penetration as shown in FIG. 8B and show an impulse response when characteristics of the obstacle penetration are different for each frequency.

According to an example embodiment, an impulse response may be generated based on ray tracing which determines a path of a ray from a transmitter to a receiver. In this case, an impulse-response generating apparatus 200 may identify whether a direct sound is included in the impulse response generated by the ray tracing. When the direct sound is included in the impulse response generated by the ray tracing, the impulse response generating apparatus 200 may still use the impulse response generated by the ray tracing. In addition, when the direct sound is not included in the impulse response generated by the ray tracing, the impulse response generating apparatus 200 may reflect a path, through which the direct sound penetrates an obstacle, in the impulse response generated by the ray tracing.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductive wire memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by or incorporated in special-purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single example embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In specific cases, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure but are not intended to limit the scope of the present disclosure. It will be apparent to those skilled in the art that various modifications based on the technical spirit of the present disclosure, as well as the disclosed example embodiments, can be made.

What is claimed is:

1. A method of generating an impulse response, the method comprising:
calculating a number of rays reaching a receiver from a transmitter based on acoustic geometry information including a position of the transmitter and a position of the receiver disposed in a sound space, a maximum ray length or a sound space volume, and a radius of the receiver;
tracing the rays using a path of the calculated rays;
generating an impulse response based on the traced rays.

2. The method of claim 1, wherein the calculating of the number of the rays comprises calculating the number of the rays based on the radius of the receiver and the maximum ray length.

3. The method of claim 1, wherein the calculating of the number of the rays comprises calculating the number of the rays based on the radius of the receiver and the sound space volume.

4. The method of claim 1, wherein the generating of the impulse response comprises generating the impulse response based on a direct sound representing a ray corresponding to a path directly reaching the receiver from the transmitter and a reflected sound representing a ray corresponding to a path originating from the transmitter and reaching the receiver after reflection in the sound space.

5. The method of claim 1 wherein a size of the receiver is set to be the same as or similar to a size of a listener's head.

6. A method of generating an impulse response, the method comprising:
calculating a number of rays reaching a receiver from a transmitter based on acoustic geometry information including a position of the transmitter and a position of the receiver disposed in a sound space, a maximum ray length or a sound space volume, and a radius of the receiver;
tracing the rays using a path of the calculated rays;
generating an impulse response based on the traced rays; and
reflecting a penetration path of a direct sound in the impulse response according to whether the direct sound is included in the impulse response.

7. The method of claim 6, wherein the calculating of the number of the rays comprises calculating the number of the rays based on the radius of the receiver and the maximum ray length.

8. The method of claim 6, wherein the calculating of the number of the rays comprises calculating the number of the rays based on the radius of the receiver and the sound space volume.

9. The method of claim 6, wherein the generating of the impulse response comprises generating the impulse response based on the direct sound representing a ray corresponding to a path directly reaching the receiver from the transmitter and a reflected sound representing a ray corresponding to a path originating from the transmitter and reaching the receiver after reflection in the sound space.

10. The method of claim 6, wherein the reflecting in the impulse response comprises outputting the impulse response generated based on the traced rays, as it is, when the direct sound is included in the impulse response.

11. The method of claim 6, wherein the reflecting in the impulse response comprises reflecting, in the impulse response, the direct sound corresponding to a path penetrating an obstacle disposed in the sound space when the direct sound is not included in the impulse response.

12. The method of claim 11, wherein the direct sound corresponding to the path penetrating the obstacle is determined differently according to characteristics of penetrating the obstacle.

13. The method of claim 6, wherein the reflecting in the impulse response comprises determining that the direct sound is included in the impulse response according to whether a length of an impulse path occurring at a closest distance from the impulse response is equal to a distance between the transmitter and the receiver.

14. The method of claim 6, wherein a size of the receiver is set to be the same as or similar to a size of a listener's head in the sound space.

15. An impulse-response generating apparatus, the apparatus comprising:
a processor,
wherein the processor is configured to:
calculate a number of rays reaching a receiver from a transmitter based on acoustic geometry information including a position of the transmitter and a position of the receiver disposed in a sound space, a maximum ray length or a sound space volume, and a radius of the receiver;
trace the rays using a path of the calculated rays;
generate an impulse response based on the traced rays; and
reflect a penetration path of a direct sound in the impulse response according to whether the direct sound is included in the impulse response.

16. The apparatus of claim 15, wherein the processor is configured to:
calculate the number of the rays based on the radius of the receiver and the maximum ray length; or
calculate the number of the rays based on the radius of the receiver and the sound space volume.

17. The apparatus of claim 15, wherein a size of the receiver is set to be the same as or similar to a size of a listener's head in the sound space.

18. The apparatus of claim 15, wherein the processor is configured to generate the impulse response based on the direct sound representing a ray corresponding to a path directly reaching the receiver from the transmitter and a reflected sound representing a ray corresponding to a path originating from the transmitter and reaching the receiver after reflection in the sound space.

19. The apparatus of claim 15, wherein the processor is configured to:
output the impulse response generated based on the traced ray, as it is, when the direct sound is included in the impulse response; and
reflect, in the impulse response, the direct sound corresponding to a path penetrating an obstacle disposed in the sound space when the direct sound is not included in the impulse response.

20. The apparatus of claim 15, wherein the processor is configured to determine that the direct sound is included in the impulse response according to whether a length of an impulse path occurring at a closest distance in the impulse response is equal to a distance between the transmitter and the receiver.
